(19) United States
(12) Patent Application Publication
(10) Pub. No.: US 2024/0422302 A1
(43) Pub. Date: Dec. 19, 2024

(54) SYSTEMS AND METHODS FOR IMAGE CAPTURE FOR EXTENDED REALITY APPLICATIONS USING PERIPHERAL OBJECT

(71) Applicant: Apple Inc., Cupertino, CA (US)

(72) Inventors: Kevin A. COLEY, San Francisco, CA (US); Ronald V. SIY, San Francisco, CA (US)

(21) Appl. No.: 18/675,923

(22) Filed: May 28, 2024

Related U.S. Application Data
(60) Provisional application No. 63/508,486, filed on Jun. 15, 2023.

(51) Int. Cl. H04N 13/221; G06F 3/16; H04N 13/156; H04N 13/293

(52) U.S. Cl. CPC H04N 13/221; G06F 3/16; H04N 13/156; H04N 13/293

(57) ABSTRACT

A first device optionally presents a representation of an input device at a first location in a three-dimensional environment with a position and orientation in the three-dimensional environment that is based on a position and orientation of an input device in a physical environment. While presenting the representation of the input device at the first location in the three-dimensional environment, the first device optionally detects an input to capture one or more images from a) a perspective corresponding to the input device, and/or b) a perspective corresponding to the representation of the input device, and in response to detecting the input, the first device optionally captures the one or more images from a) the perspective corresponding to the input device, and/or b) the perspective corresponding to the representation of the input device.

### CROSS-REFERENCE TO RELATED APPLICATIONS

This application claims the benefit of U.S. Provisional Application No. 63/508,486, filed Jun. 15, 2023, the content of which is herein incorporated by reference in its entirety for all purposes.

### FIELD OF THE DISCLOSURE

The present disclosure relates generally to computer systems that provide computer-generated experiences, including, but not limited to, electronic devices that provide extended reality experiences via a display.

### BACKGROUND OF THE DISCLOSURE

A camera captures an image or video in a physical environment, which can be viewed.

### SUMMARY OF THE DISCLOSURE

Some aspects of the disclosure provide systems and methods for capturing one or more images and/or audio of an environment, such as an extended reality environment (e.g., a virtual environment, an augmented reality environment, a mixed reality environment) or a physical environment. Some aspects of the disclosure provide systems and methods for presenting captured one or more images and/or audio of the environment in the same environment in which the one or more images and/or audio was captured, and/or in a different environment than the environment corresponding to the captured one or more images and/or audio. For example, some aspects of the disclosure provide systems and methods for rendering (e.g., displaying) two-dimensional images of a three-dimensional environment, such as a three-dimensional virtual environment, three-dimensional augmented reality environment, and/or a three-dimensional physical environment. Some aspects of the disclosure provide systems and methods for presenting the two-dimensional images in the same environment in which the one or more images was captured, and/or in a different environment than the environment corresponding to the captured one or more images and/or audio.

In some aspects, a first device is in communication with an input device, and the first device displays a virtual environment from a perspective of a user immersed in the virtual environment. In some aspects, the view of the virtual environment that the first device displays is based on a position and/or orientation of the first device in the physical environment. In some aspects, while displaying the virtual environment, the first device displays a representation of input device (e.g., a three-dimensional virtual object) having a position and orientation in the virtual environment that is based on a position and orientation of the input device in the physical environment. In some aspects, the first device captures one or more images of the virtual environment from the perspective of the representation of input device in the virtual environment. In some aspects, the first device captures audio of the virtual environment from the perspective (e.g., virtual spatial perspective) of the representation of input device in the virtual environment. In some aspects, the first device displays on the virtual object one or more images (e.g., one or more two-dimensional images) of the virtual environment from the perspective of the virtual object in the virtual environment (optionally as opposed to from the perspective of the user immersed in the virtual environment).

The full descriptions of these examples are provided in the Drawings and the Detailed Description, and it is understood that the Summary presented herein does not limit the scope of the disclosure in any way. In addition, the Drawings and the Detailed Description provide other examples.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates a block diagram of an example architecture for a system according to some examples of the disclosure.

FIG. 2 illustrates a physical environment including a first device and an input device having a first position and orientation, and illustrates a virtual environment that includes a representation of an input device having a first position and orientation that is based on the first position and orientation of the input device in the physical environment, according to some examples of the disclosure.

FIG. 3 illustrates the physical environment of FIG. 2, with the input device having a second position and orientation, and illustrates the virtual environment of FIG. 2 including the representation of input device having a second position and orientation that is based on the second position and orientation of the input device in the physical environment, according to some examples of the disclosure.

FIG. 4 illustrates the physical environment of FIG. 2, and illustrates the virtual environment of FIG. 2 with the representation of the input device including a representation of a display screen at the first position and orientation that displays a view of virtual environment from the perspective of the representation of input device, according to some examples of the disclosure.

FIG. 5 illustrates a view of the virtual environment of FIG. 2 from a perspective of the user of the first device, according to some examples of the disclosure.

FIG. 6 illustrates the physical environment of FIG. 2, and illustrates the virtual environment of FIG. 2 with the representation of the input device including a representation of the display screen at the first position and orientation that displays a view of the physical environment from the perspective of the input device, according to some examples of the disclosure.

FIG. 7 illustrates the physical environment of FIG. 2, but including a second person in the physical environment and the input device having a third position and orientation displaying a view of the virtual environment of FIG. 2, and illustrates the virtual environment of FIG. 2 with the representation of the input device having a third position and orientation that is based on the third position and orientation of the input device in the physical environment, according to some examples of the disclosure.

FIG. 8 illustrates the physical environment of FIG. 3, and illustrates the virtual environment of FIG. 3 with the representation of the input device including a representation of a display screen at the second position and orientation displaying an image of an augmented reality environment, according to some examples of the disclosure.

FIG. 9 flow diagram illustrating operations and communications that the first device and/or the input device performs, according to some examples of the disclosure.

FIG. 10 illustrates a diagram of a method for capturing one or more images of an environment, according to some examples of the disclosure.

### DETAILED DESCRIPTION

Some aspects of the disclosure provide systems and methods for capturing one or more images and/or audio of an environment, such as an extended reality environment (e.g., a virtual environment, an augmented reality environment, a mixed reality environment) or a physical environment. Some aspects of the disclosure provide systems and methods for presenting captured one or more images and/or audio of the environment in the same environment in which the one or more images and/or audio was captured, and/or in a different environment than the environment corresponding to the captured one or more images and/or audio. For example, some aspects of the disclosure provide systems and methods for rendering (e.g., displaying) two-dimensional images of a three-dimensional environment, such as a three-dimensional virtual environment, three-dimensional augmented reality environment, and/or a three-dimensional physical environment. Some aspects of the disclosure provide systems and methods for presenting the two-dimensional images in the same environment in which the one or more images was captured, and/or in a different environment than the environment corresponding to the captured one or more images and/or audio.

In some aspects, a first device is in communication with an input device, and the first device displays a virtual environment from a perspective of a user immersed in the virtual environment. In some aspects, the view of the virtual environment that the first device displays is based on a position and/or orientation of the first device in the physical environment. In some aspects, while displaying the virtual environment, the first device displays a representation of input device (e.g., a three-dimensional virtual object) having a position and orientation in the virtual environment that is based on a position and orientation of the input device in the physical environment. In some aspects, the first device captures one or more images of the virtual environment from the perspective of the representation of input device in the virtual environment. In some aspects, the first device captures audio of the virtual environment from the perspective (e.g., virtual spatial perspective) of the representation of input device in the virtual environment. In some aspects, the first device displays on the virtual object one or more images (e.g., one or more two-dimensional images) of the virtual environment from the perspective of the virtual object in the virtual environment (optionally as opposed to from the perspective of the user immersed in the virtual environment).

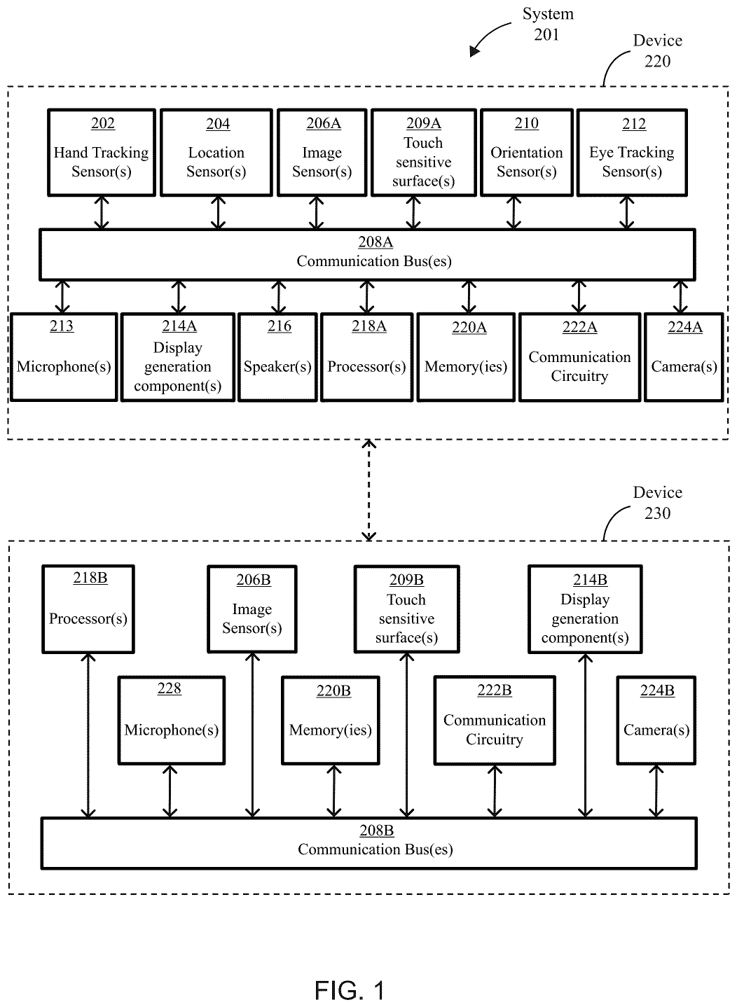

FIG. 1 illustrates a block diagram of an example architecture for a system 201 according to some examples of the disclosure.

System 201 includes a first electronic device 220 and a second electronic device 230. The first electronic device 220 and the second electronic device 230 are communicatively coupled. The first electronic device 220 is optionally a head mounted device, a mobile phone, smart phone, a tablet computer, a laptop computer, an auxiliary device in communication with another device, and/or another type of portable, nonportable, wearable, and/or nonwearable device. The second electronic device 230 is optionally similar or different in kind from the first electronic device. For example, when the first electronic device 220 is a head mounted device, the second electronic device 230 is optionally a mobile phone.

As illustrated in FIG. 1, first electronic device 220 optionally includes (e.g., is in communication with) various sensors (e.g., one or more hand tracking sensor(s) 202, one or more location sensor(s) 204, one or more image sensor(s) 206A, one or more touch-sensitive surface(s) 209A, one or more motion and/or orientation sensor(s) 210, one or more eye tracking sensor(s) 212, one or more microphone(s) 213 or other audio sensors), one or more display generation component(s) 214A, one or more speaker(s) 216, one or more processor(s) 218A, one or more memories 220A, and/or communication circuitry 222A. Second electronic device 230 optionally includes various sensors (e.g., one or more image sensor(s) such as camera(s) 224B, one or more touch-sensitive surface(s) 209B, and/or one or more microphones 228), one or more display generation component(s) 214B, one or more processor(s) 218B, one or more memories 220B, and/or communication circuitry 222B. One or more communication buses 208A and 208B are optionally used for communication between the above-mentioned components of devices 220 and 230, respectively. First electronic device 220 and second electronic device 230 optionally communicate via a wired or wireless connection (e.g., via communication circuitry 222A-222B).

Communication circuitry 222A, 222B optionally includes circuitry for communicating with electronic devices, networks, such as the Internet, intranets, a wired network and/or a wireless network, WiFi, cellular networks (e.g., 3G, 5G), and wireless local area networks (LANs). Communication circuitry 222A, 222B optionally includes circuitry for communicating using near-field communication (NFC) and/or short-range communication, such as Bluetooth®.

Processor(s) 218A, 218B optionally include one or more general processors, one or more graphics processors, and/or one or more digital signal processors. In some examples, memory 220A, 220B is a non-transitory computer-readable storage medium (e.g., flash memory, random access memory, or other volatile or non-volatile memory or storage) that stores computer-readable instructions configured to be executed by processor(s) 218A, 218B to perform the techniques, processes, and/or methods described below. In some examples, memory 220A, 220B can include more than one non-transitory computer-readable storage medium (optionally that stores computer-readable instructions configured to be executed by processor(s) 218A, 218B to perform the techniques, processes, and/or method 1000 described below). A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

In some examples, display generation component(s) 214A, 214B include a single display (e.g., a liquid-crystal display (LCD), organic light-emitting diode (OLED), or other types of display). In some examples, display generation component(s) 214A, 214B includes multiple displays. In some examples, display generation component(s) 214A, 214B can include a display with touch capability (e.g., a touch screen), a projector, a holographic projector, a retinal projector, etc. In some examples, electronic devices 220 and/or 230 include touch-sensitive surface(s) 209A and 209B, respectively, for receiving user inputs, such as tap inputs and swipe inputs or other gestures. For example, electronic device 230 optionally includes a touch-sensitive surface while electronic device 220 does not include a touch-sensitive surface. In some examples, display generation component(s) 214A,214B and touch-sensitive surface(s) 209A, 209B form touch-sensitive display(s) (e.g., a touch screen integrated with devices 220 and 230, respectively, or external to devices 220 and 230, respectively, that is in communication with devices 220 and 230).

Electronic devices 220 and/or 230 optionally includes image sensor(s). Image sensors(s) 206A and/or 206B optionally include one or more visible light image sensors, such as charged coupled device (CCD) sensors, and/or complementary metal-oxide-semiconductor (CMOS) sensors operable to obtain images of physical objects from the real-world environment. Image sensor(s) 206A and/or 206B also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206A and 206B also optionally include one or more cameras 224A and 224B, respectively, configured to capture images of objects in the physical environment. Image sensor(s) 206A and/or 206B also optionally include one or more depth sensors configured to detect the distance of physical objects from device 220/230. In some examples, the system 201 utilizes data from one or more depth sensors to identify and differentiate objects in the real-world environment from other objects in the real-world environment and/or to determine the texture and/or topography of objects in the real-world environment.

In some examples, electronic devices 220 and/or 230 use CCD sensors, event cameras, and depth sensors in combination to detect the physical environment around devices 220 and/or 230. In some examples, image sensor(s) 206A include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, the image sensor(s) 206B includes two image sensors and are configured to perform functions similar to the above-recited functions of image sensor(s) 206A. In some examples, device 220/230 uses image sensor(s) 206A to detect the position and orientation of device 220/230 and/or display generation component(s) 214A/214B in the real-world environment. For example, device 220/230 uses image sensor(s) 206A/206B to track the position and orientation of display generation component(s) 214A/214B relative to one or more fixed objects in the real-world environment. In some examples, the system 201 uses image sensor(s) 206A to detect the position and orientation of electronic device 230 relative to electronic device 220.

In some examples, device 220 includes microphone(s) 213 or other audio sensors. Device 220 uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Device 220 includes location sensor(s) 204 for detecting a location of device 220 and/or display generation component(s) 214A. For example, location sensor(s) 204 can include a Global Positioning System (GPS) receiver that receives data from one or more satellites and allows device 220 to determine the device's absolute position in the physical world.

Device 220 includes orientation sensor(s) 210 for detecting orientation and/or movement of device 220 and/or display generation component(s) 214A. For example, device 220 uses orientation sensor(s) 210 to track changes in the position and/or orientation of device 220 and/or display generation component(s) 214A, such as with respect to physical objects in the real-world environment. Orientation sensor(s) 210 optionally include one or more gyroscopes, one or more accelerometers, and/or one or more inertial measurement units (IMUs).

Device 220 includes hand tracking sensor(s) 202 and/or eye tracking sensor(s) 212, in some examples. Hand tracking sensor(s) 202 are configured to track the position/location of one or more portions of the user's hands, and/or motions of one or more portions of the user's hands with respect to the extended reality environment, relative to the display generation component(s) 214A, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214A. In some examples, hand tracking sensor(s) 202 and/or eye tracking sensor(s) 212 are implemented together with the display generation component(s) 214A. In some examples, the hand tracking sensor(s) 202 and/or eye tracking sensor(s) 212 are implemented separate from the display generation component(s) 214A.

In some examples, the hand tracking sensor(s) 202 can use image sensor(s) 206A (e.g., one or more IR cameras, 3D cameras, depth cameras, etc.) that capture three-dimensional information from the real-world including one or more hands (e.g., of a human user). In some examples, the hands can be resolved with sufficient resolution to distinguish fingers and their respective positions. In some examples, one or more image sensor(s) 206A are positioned relative to the user to define a field of view of the image sensor(s) 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by a respective eye tracking camera/illumination source(s).

Device 220/230 and system 201 are not limited to the components and configuration of FIG. 1, but can include fewer, other, or additional components in multiple configurations. In some examples, system 201 can be implemented in a single device. A person or persons using device 220/230 or system 201, is optionally referred to herein as a user or users of the device(s). Additionally or alternatively, in some examples, electronic device 220 tracks a device (e.g., a cup, a box, a pen, or another device) that is not an electronic device. For example, the electronic device 220 optionally tracks an object that does not any of the illustrated components of device 230.

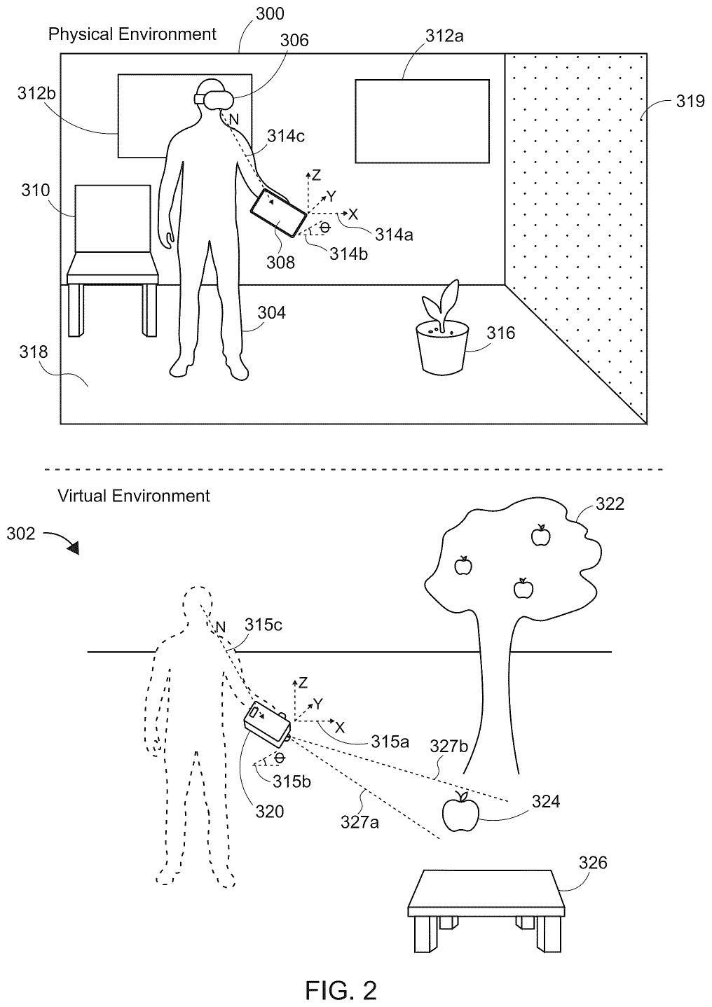

FIG. 2 illustrates a physical environment 300 and a virtual environment 302 in which a user 304 is immersed (e.g., fully immersed). The physical environment 300 (e.g., a room, an office) includes a user 304, a first device 306 (e.g., a head mounted display system, an extended reality (XR) display system), and an input device 308. First device 306 optionally includes one or more features of device 220 of FIG. 1. Input device 308 optionally includes one or more features of device 230 of FIG. 1. In FIG. 2, physical environment 300 also includes chair 310, windows 312a and 312b, plant 316 on floor 318, and wall 319.

In some examples, input device 308 is an electronic device, such as a mobile phone, a laptop, a watch, a remote. In some examples, input device 308 is a non-electronic object, such as a non-electronic block, a non-electronic cup, a non-electronic wallet, or another non-electronic object. Further discussion of input device 308 is provided below.

In FIG. 2, in physical environment 300, input device 308 has a position and orientation within a representative coordinate system 314a. Angle 314b is optionally representative of an angle corresponding to an orientation (e.g., relative to a horizontal of physical environment 300 or another reference object (e.g., relative to first device 306), axis, or plane) of input device 308 in physical environment 300. Vector 314c is optionally a vector representative of a vector (e.g., a position vector) between first device 306 and input device 308, with the length (e.g., the magnitude) of the vector representative of a distance between the position of first device 306 and input device 308 in physical environment 300. In some examples, input device 308 includes sensors (e.g., position sensors, orientation sensors, accelerometers, gyroscopes, IMUs, or other sensors) that are used to detect the position and orientation of input device 308 in physical environment 300; first device 306 optionally receives transmission of data corresponding to the sensor data detected via input device 308 that is used to detect the position and orientation of input device 308 in physical environment 300 (that, optionally is relative to the position and orientation of the first device 306 in physical environment 300). In some examples, first device 306 detects the position and orientation of the input device via sensors of first device 306 (e.g., image sensors). For example, a position of input device 308 relative to first device 306 and/or a distance between input device 308 and first device 306, as illustrated with vector 314c, is optionally detected by the first device 306. In some examples, first device 306 detects the position and orientation of input device 308 via data streams (e.g., data packets) from input device 308 (optionally through BLUETOOTH) or another suitable wired or wireless medium. In some examples, first device 306 uses the spatial relationship of first device 306 and input device 308 (e.g., distance between first device 306 and input device 308 in physical environment 300 and orientation of input device 308 relative to first device 306 (e.g., relative to an external forward-facing direction of first device 306)) to understand the position and orientation of input device 308 relative to first device 306. Additionally, an orientation of input device 308 is optionally detected by the first device 306. As such, the position and orientation of the input device 308 is optionally relative to a reference (e.g., a spatial reference, an orientation reference, direction of gravity, or another type of reference) in the physical environment 300, such as relative to floor 318, gravity, and/or first device 306.

In FIG. 2, user 304 is immersed into virtual environment 302 (e.g., a virtual scene via first device 306. The virtual environment optionally includes a visual scene in which the user is fully or partially immersed, such as a scene of a campground, of a sky, of outer space, and/or other suitable virtual scenes. In some examples, the virtual environment is a simulated three-dimensional environment that is displayed in the three-dimensional environment, optionally instead of the representations of the physical environment (e.g., full immersion) or optionally concurrently with the representation of the physical environment (e.g., partial immersion). Some examples of a virtual environment include a lake environment, a mountain environment, a sunset scene, a sunrise scene, a nighttime environment, a grassland environment, and/or a concert scene. In some examples, a virtual environment is based on a real physical location, such as a museum and/or an aquarium, or is based on an artist-designed location. Thus, displaying a virtual environment in the three-dimensional environment optionally provides the user with a virtual experience as if the user is physically located in the virtual environment. In FIG. 2, the user is optionally fully immersed into virtual environment 302.

In FIG. 2, first device 306 displays virtual environment 302, including a representation of input device 320 and virtual objects, including a representation of apple tree 322, a representation of apple 324 that is on a virtual ground, and a representation of table 326. The representation of the input device 320 (e.g., virtual object) is optionally a virtual camera simulated by first device 306 (e.g., a representation of an image capture device) that can capture an image or video in virtual environment 302 from the perspective of the representation of input device 320. In some examples, the representation of input device 320 is a representation of a camera, such as an analog camera, a digital camera, a film camera, a video camera, or another type of camera or image capture device. In some examples, the representation of the input device 320 includes a tripod and/or a selfie stick (optionally regardless of whether input device 308 includes a tripod and/or a selfie stick). In some examples, the appearance of input device 308 in physical environment 300 is similar to or same as the appearance of representation of input device 320 simulated by first device 306 in virtual environment 302. In some examples, the appearance of input device 308 in physical environment is different from the appearance of representation of input device 320 simulated by first device 306 in virtual environment 302. In an example, input device 308 is optionally a cup while representation of input device 320 in virtual environment is optionally a camera. In other example, input device 308 is optionally a phone while representation of input device 320 is a virtual representation of the phone or a virtual representation of a stationary camera.

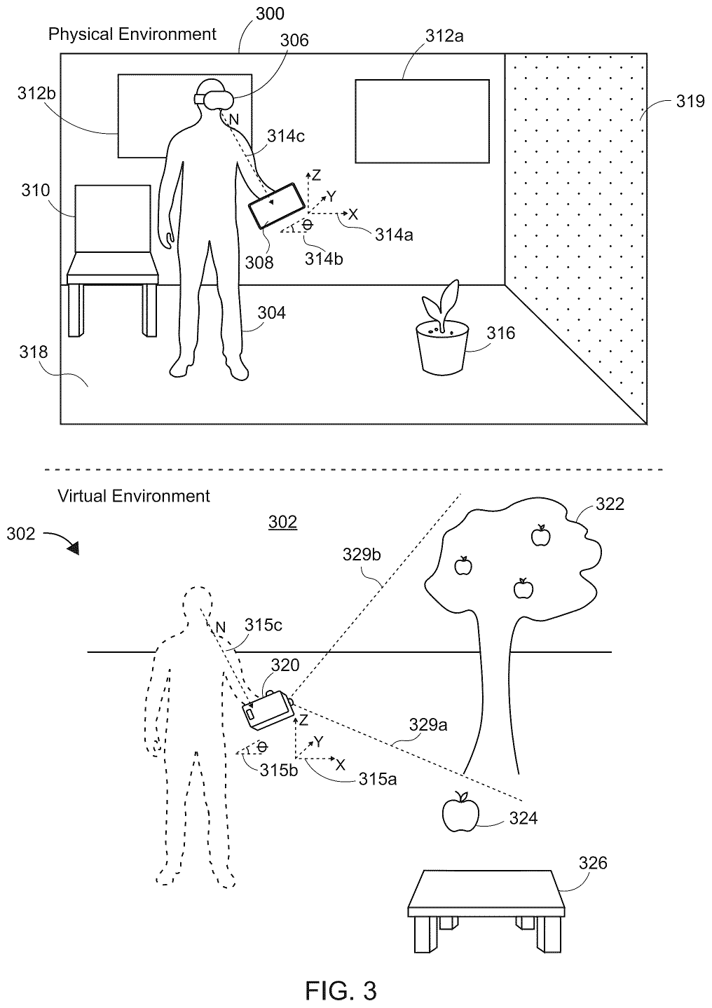

In FIG. 2, representation of input device 320 is oriented to image capture representation of apple 324, as illustrated with the viewing boundaries 327a and 327b (e.g., representing the field of view of a representation of an aperture of the input device). In FIG. 2, in virtual environment 302, representation of input device 320 has a position and orientation (e.g., in a representative virtual coordinate system 315a) that is based on the (real) position and orientation of input device 308 in the physical environment 300 (e.g., based on the position and orientation of input device 308 within the representative coordinate system 314a. For example, angle 315b optionally corresponds to angle 314b, but in virtual environment 302, and vector 315c optionally corresponds to vector 314c, but in virtual environment 302. In virtual environment 302, angle 315b and/or vector 315c are optionally the same as (or otherwise based on (e.g., are a function of)) angle 314b and/or vector 314c in physical environment 300. When first device 306 detects a change in a position and/or orientation of input device 308, first device 306 optionally updates a position and/or orientation of representation of input device 320 in virtual environment 302. For example, in FIG. 2, first device 306 displays in virtual environment 302 representation of input device 320 with a first orientation and first position (that are based on the orientation and position of input device 308 in physical environment 300 of FIG. 2). Continuing with this example, in FIG. 2, representation of input device 320 is oriented to image capture representation of apple 324, and in response to first device 306 detecting a change in the position and/or orientation of input device 308, in accordance with a determination that the change in the position and/or orientation of input device 308 results in the position and orientation of input device 308 in FIG. 3, first device 306 optionally updates position and orientation of representation of input device 320 such that representation of input device 320 is oriented (e.g., re-oriented) to image capture representation of apple tree 322, such as shown in FIG. 3 with the viewing bounds 329a and 329b that cover representation of apple tree 322. As such, first device 306 optionally orients a position and/or orientation of representation of input device 320 based on a position and/or orientation of input device 308.

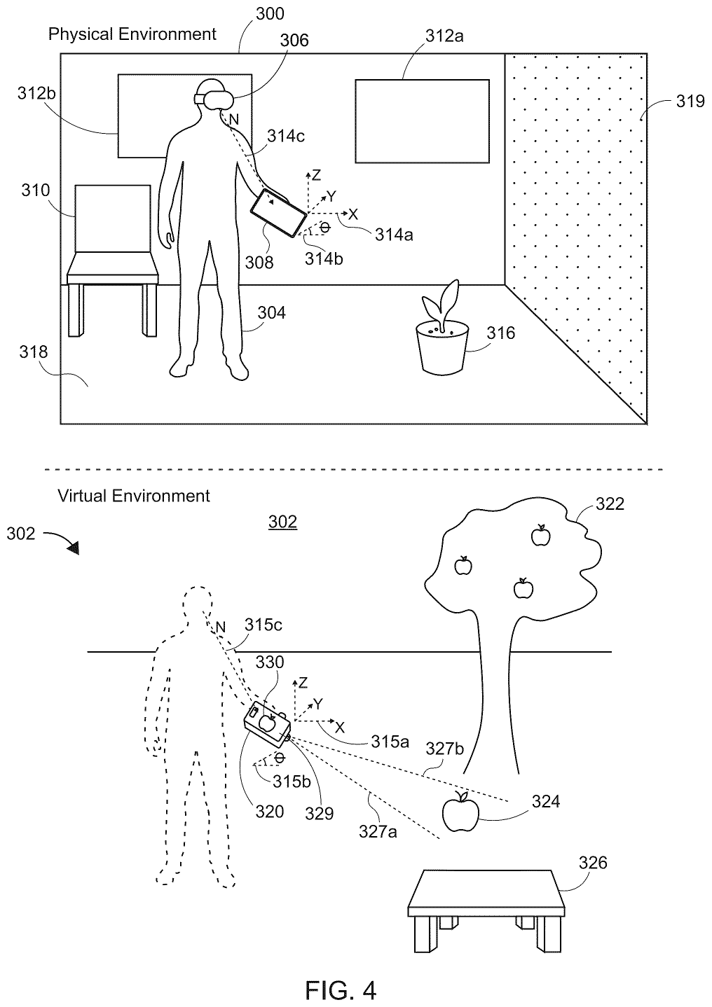

Returning back to FIG. 2, in virtual environment 302, the view of virtual environment 302 from the perspective of representation of input device 320 includes representation of apple 324, without including representation of apple tree 322 and representation of table 326, as the former (e.g., representation of apple 324) is within the viewing boundaries 327a and 327b corresponding to representation of input device 320, whereas the latter (e.g., representation of apple tree 322 and representation of table 326) are outside the viewing boundaries 327a and 327b corresponding to representation of input device 320. Just like a physical camera optionally includes zoom functionality, the viewing angle boundaries of representation of input device 320 can be enlarged or reduced (e.g., via user input) and/or the magnification modified, such that, for example, the image sensing view of representation of input device 320 optionally includes representation of apple tree 322 and table 326 in addition to representation of apple 324 (e.g., zoom-out) or the image sensing view of representation of input device 320 includes a just a portion of representation of apple 324 (e.g., zoom-in). It should be noted that representation of input device 320 optionally includes focus modes, zoom modes, filter modes, selfie modes, landscape orientation, portrait orientation, a simulated flash, representations of lenses, representations of film, and/or other digital, analog, and/or physical features of a physical camera of any type. In some examples, first device 306 displays on representation of input device 320 a view of virtual environment 302 from the perspective (e.g., position and orientation) of the representation of input device 320, such as shown in FIG. 4 with the representation of input device 320 including image data 329 including a representation of apple 330.

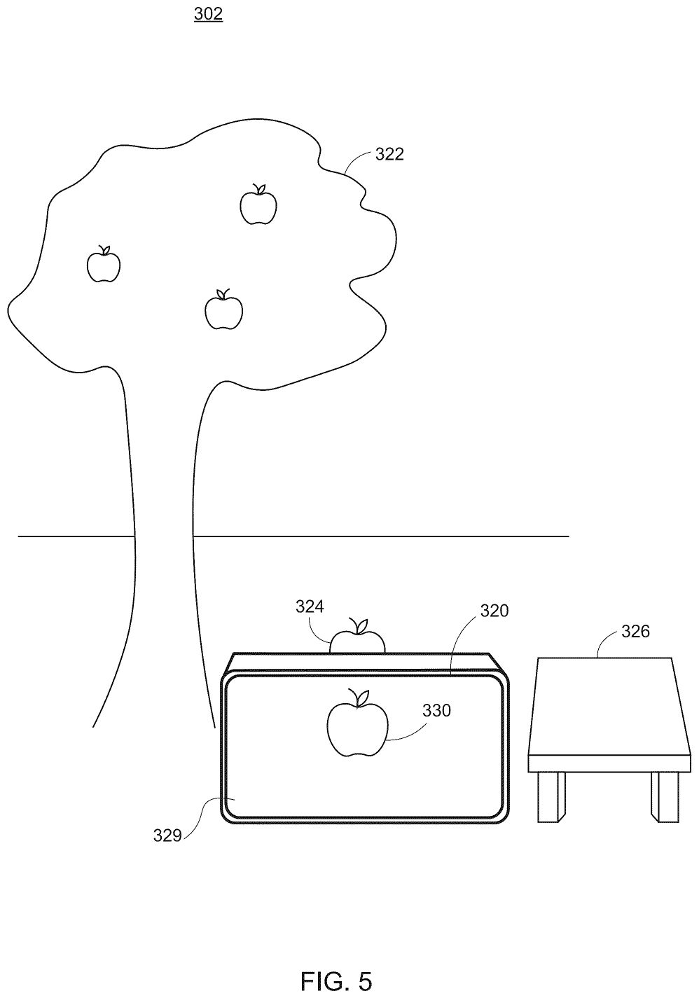

In some examples, while representation of input device 320 is oriented and positioned as shown in FIG. 2, first device 306 optionally detects an input to capture the image corresponding to the viewpoint of representation of input device 320. In some examples, first device 306 detects, via sensors, a capture input including a gaze and/or gesture(s) directed toward input device 308 and/or representation of input device 320. For example, the gaze and/or gesture(s) are detected directed toward a user interface of representation of input device 320, a virtual button displayed on representation of input device 320, and/or a physical touch-sensitive portion of input device 308 (e.g., detection of touch) or button of input device 308 (e.g., detection of pressing the button of input device 308). The gaze and/or gesture(s) optionally correspond to the capture input. In some examples, physical buttons on input device 308 are mapped to virtual buttons that first device 306 displays on representation of input device 320, such that selection of a first physical button on input device 308 corresponds to selection of a first virtual button or user interface element on representation of input device 320. In some examples, one or more or all virtual buttons that first device 306 displays on representation of input device 320 do not correspond to physical buttons on input device 308, though the virtual buttons can be triggered by inputs (e.g., touch, capacitive, press, or press and hold inputs) at location(s) of physical buttons on input device 308 or at locations on input device 308 without physical buttons. In response to detecting the capture input, first device 306 optionally captures the viewpoint of the virtual environment 302 from the perspective of representation of input device 320, such as shown in FIG. 5.

FIG. 5 illustrates a view of virtual environment 302 of FIG. 2 from the perspective of the user 304 of first device 306 of FIG. 2. In FIG. 5, the view of virtual environment 302 of FIG. 2 from the perspective of the user 304 of first device 306 of FIG. 2 includes representation of input device 320 and virtual objects, including a representation of apple tree 322, a representation of apple 324, a representation of table 326, and a second representation of apple 330 displayed on representation of input device 320. Representation of apple 324 and representation of apple 330 correspond to the same representation of apple in virtual environment 302, though first device 306 displays two different representations of the same apple in two different locations. In FIG. 5, first device 306 displays, in virtual environment 302, two representations of the same apple because in the view of the virtual environment 302 from the perspective of user 304, the representation of input device 320 is positioned and oriented such that it does not fully obscure visibility of representation of apple 324. In some examples, based on the position and orientation of representation of input device 320, the first device 306 displays second representation of apple 330 without displaying representation of apple 324, optionally because in the view of virtual environment 302 from the perspective of user 304, representation of input device 320 fully obscures display of representation of apple 324 (optionally such first device displays representation of apple 330 without representation of apple 324). In addition, it should be noted that representation of apple 330 is optionally a two-dimensional image of representation of apple 324, which is optionally three-dimensional.

In FIG. 5, representation of input device 320 (e.g., virtual camera) includes representation of apple 330 that is on a virtual ground, without including representation of apple tree 322 and table 326, which are outside of the coverage of the representation of input device 320. As such, image(s) are optionally captured (e.g., via first device 306) from the perspective (e.g., position and orientation) of representation of input device 320 (e.g., virtual camera) displayed by first device 306 rather than from the perspective (e.g., position and orientation) of first device 306 in virtual environment; thus, first device 306 optionally simulates representation of input device 320 capturing an image or video in a virtual environment and displaying the image or video on representation of input device 320 visually similar to how a physical camera including a user interface can capture an image or video of a physical environment and display the image or video on the user interface of the physical camera. In some examples, the captured image includes an image orientation, such as a portrait, square, or landscape orientation. In some examples, the image orientation of the captured image is based on image orientation functionality of representation of input device 320, which optionally is or is not based on an image orientation functionality of input device 308. In some examples, representation of input device 320 includes more, same amount and same kind, or fewer image orientation types than input device 308. In some examples, representation of input device 320 includes a single image orientation functionality while input device 308 includes more than a single image orientation functionality (e.g., portrait and landscape). In some examples, representation of input device 320 includes image orientation functionality while input device 308 does not include any image orientation functionality for capturing images in physical environment 300.

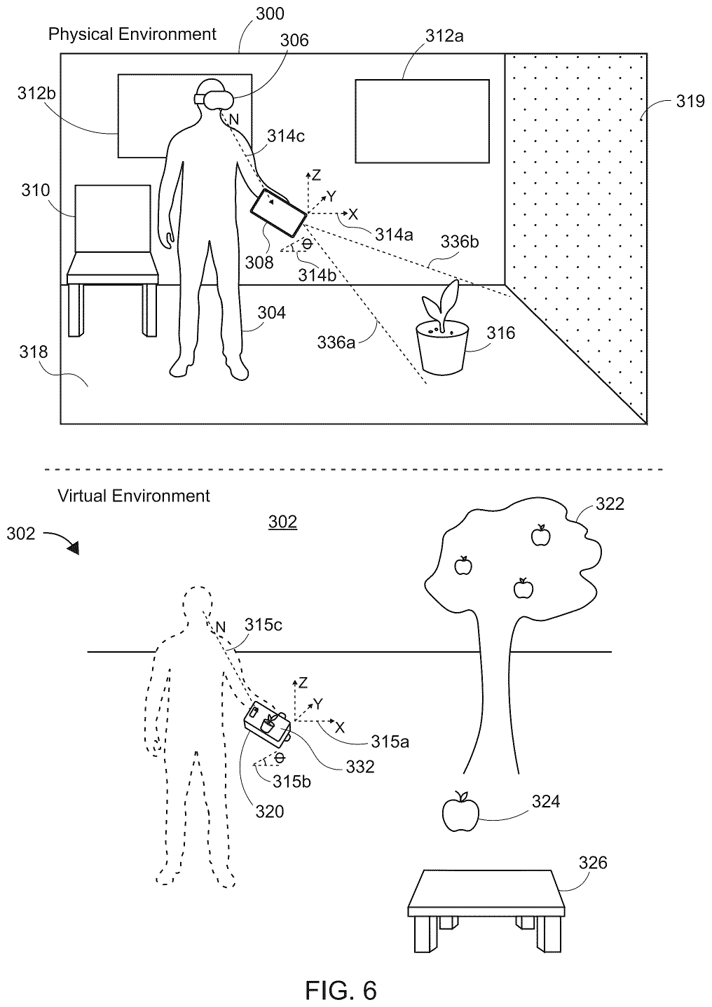

FIG. 6 illustrates the physical environment of FIG. 2, and the virtual environment of FIG. 2 with representation of input device 320 having the first position and orientation and including the representation of the display screen at the first position and orientation that displays a view of the physical environment from the perspective of the input device, according to some examples of the disclosure. In physical environment 300 of FIG. 6, input device 308 optionally includes an image sensor (e.g., an image capture device or component) that captures image data of a portion of the physical environment 300 that includes plant 316, as illustrated with the viewing bounds 336a and 336b. Input device 308 optionally transmits the image data to first device 306, and in response, first device 306 displays the image data captured by input device 308 in the physical environment 300. In FIG. 6, input device 308 in physical environment 300 drives the position and orientation of representation of input device 320 in virtual environment 302 (and, optionally the images that are displayed on representation of input device 320 in virtual environment 302). For example, when input device 308 faces a first direction in physical environment 300 (e.g., has a first orientation in physical environment 300), representation of input device 320 optionally faces a first direction in virtual environment 302 (e.g., has a first orientation in virtual environment 302) and includes image data of physical environment 300 from input device 308 that is facing the first direction in physical environment 300; when input device 308 faces a second direction in physical environment 300 (e.g., has a second orientation in physical environment 300), different from the first direction, representation of input device 320 optionally faces a second direction in virtual environment 302 (e.g., has a second orientation in virtual environment 302), different from the first direction in physical environment 300 and includes image data of physical environment 300 from input device 308 that is facing the second direction in physical environment 300.

In addition, in FIG. 6, input device 308 is optionally detecting (e.g., capturing) image data in the physical environment 300, which in the illustrated example includes a view of plant 316, and then transmitting the image data to first device 306. In FIG. 6, in response to receiving the transmission of image data from input device 308, first device 306 displays the image data 332 (e.g., image of plant 316 and floor 318) on representation of the input device 320 in virtual environment 302. As such, in FIG. 6, though representation of the input device 320 in virtual environment 302 is optionally oriented to capture representation of apple 324 in virtual environment 302, representation of the input device 320 includes the image data 332 from input device 308 in physical environment 300, without including image data from virtual environment 302 (e.g., without including representation of apple 324). As such, the first device optionally uses image data from the physical camera as a window to the physical environment while user is immersed in the virtual environment. Thus, while a user remains immersed in virtual environment 302 (e.g., without having to exit the immersive experience), first device 306 optionally utilizes one or more image sensors of input device 308 to provide a controllable view into physical environment 300. In some examples, first device 306 includes image sensors that capture images of physical environment 300 and while first device 306 displays virtual environment 302, first device 306 displays on representation of input device 320 a view of physical environment 300 that is based on the image data of physical environment 300 captured via image sensors (e.g., external image sensors) of first device 306 and is driven by the position and orientation of input device 308, optionally independent of whether input device 308 includes an image sensor for capturing an image of physical environment 300. In some examples, the image data of physical environment 300 that first device 306 displays on representation of input device 320 is a combination of image data of physical environment 300 from image data detected via image sensors of first device 306 and from image data detected via image sensors of input device 308.

In some examples, input device 308 includes a display component configured to display a user interface and displays a user interface including the image of the portion of the physical environment. For example, input device 308 of FIG. 6 optionally displays a user interface including plant 316 while first device 306 displays the image data of plant 316 on representation of input device 320 in virtual environment 302. In some examples, input device 308 includes a display component configured to display a user interface and forgoes displaying a user interface including the image of the portion of the physical environment including plant 316 while first device 306 displays the image data of plant 316 on representation of input device 320. For example, input device 308 of FIG. 6 optionally forgoes displaying a user interface including plant 316 while first device 306 displays the image data of plant 316 on representation of input device 320 in virtual environment 302 (even though input device 308 optionally includes a display component). As such, when input device 308 includes a display component, the display component is optionally active or inactive (e.g., when inactive (e.g., turned off), input device 308 optionally saves power) while first device 306 displays the view of the physical environment 300 from the perspective of input device 308 on representation of input device 320.

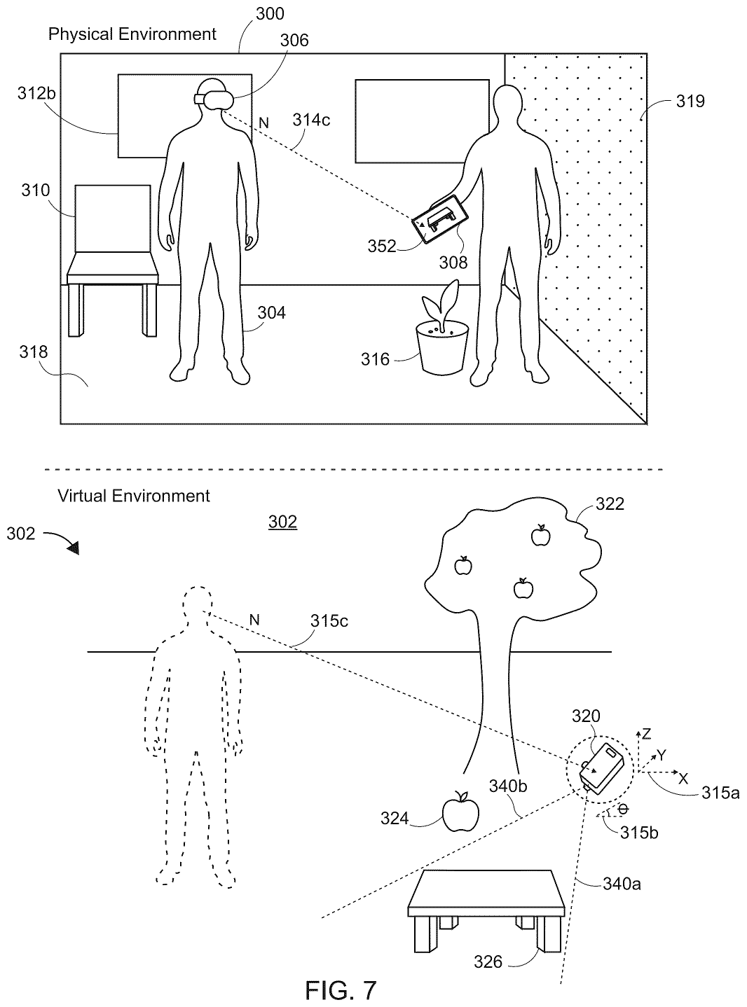

FIG. 7 illustrates the physical environment of FIG. 2, but including a second person in the physical environment and the input device having a third position and orientation and displaying a view of the virtual environment of FIG. 2, and illustrates the virtual environment of FIG. 2 with the representation of the input device having a third position and orientation, according to some examples of the disclosure. In physical environment 300 of FIG. 7, input device 308 optionally includes sensors (e.g., position, image, orientation sensors, such as described above, or other physical spatial awareness sensors) as well as a display screen. In FIG. 7, input device 308 is in communication with first device 306 and provides a view (e.g., a two-dimensional image data) of virtual environment 302, which is displayed on the display of input device 308 to the second person who does not see the display of first device 306 (e.g., does not see virtual environment 302 (e.g., a three-dimensional virtual environment). For example, first device 306 optionally detects a position and orientation of input device 308, and then transmits image data of virtual environment 302 displayed via first device 306 in accordance with the position and orientation of input device 308 in physical environment 300 (e.g., translated to the spatial relationship of the virtual environment 302 displayed via first device 306). In FIG. 7, because the view of virtual environment 302 is directed towards representation of table 326, the first device transmits a corresponding view of virtual environment 302 that includes an image 352 (e.g., a two-dimensional image) of (three-dimensional) representation of table 326 (and optionally a virtual floor on which representation of table 326 stands), as illustrated with the viewing bounds 340a and 340b. As such, in some examples, first device 306 optionally drives a view of virtual environment 302 (that is based on a position and orientation of input device 308 relative to the first device 306) to the input device 308 and input device 308 optionally presents the view on a display. These features optionally provide a user who is not immersed in virtual environment 302 with a view in virtual environment 302 that the first device 306 displays, and which is controllable using the position and orientation of input device 308.

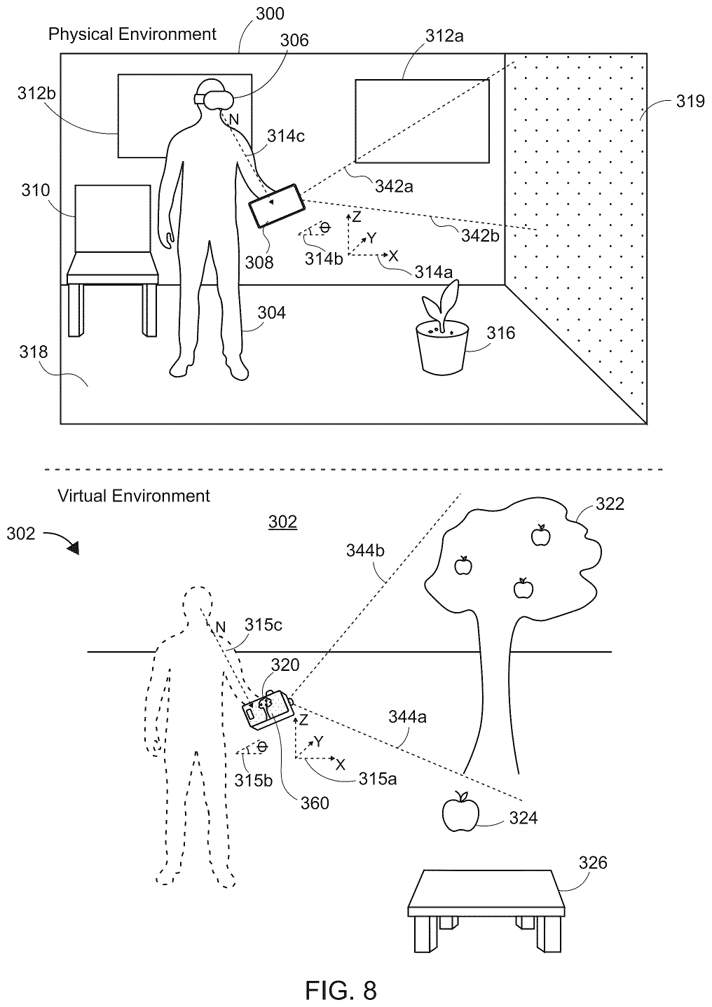

FIG. 8 illustrates the physical environment of FIG. 3, and illustrates the virtual environment of FIG. 3 with the representation of the input device including a representation of a display screen at the second position and orientation displaying an image of an augmented reality environment, according to some examples.

In physical environment 300 of FIG. 8, input device 308, optionally including an image sensor that is active, is positioned and oriented to capture image data of a portion of the physical environment including wall 319 as illustrated with viewing bounds 342a and 342b, while in virtual environment 302, first device 306 displays representation of input device 320 with a position and orientation in virtual environment 302 that is based on the position and orientation of input device 308 in physical environment 300. In virtual environment 302 of FIG. 8, the position and orientation (and zoom level) of representation of input device 320 is configured to capture representation of apple tree 322, as illustrated with viewing bounds 344a and 344b. The input device 308 optionally transmits the image data to first device 306, and first device 306 optionally composites the image data of the first device 306 with the image data in the virtual environment 302 from the perspective of representation of input device 320 to generate the augmented reality image displayed on representation of input device 320 in FIG. 8. In FIG. 8, first device 306 displays on representation of input device 320 a representation of wall 319 of physical environment 300 with representation of apple tree 322 of virtual environment 302. In some examples, the augmented reality image is composited at the first device. In some examples, the augmented reality image is composited at the input device. In some examples, the augmented reality image is composited at a device different from the first device and input device. In some examples, the composited image includes one or more images in the physical environment (e.g., an image of plant 316 or chair 310) and a virtual background corresponding to virtual environment (e.g., the background of virtual environment 302). As such, in some examples, the first device generates augmented reality images based on the position and orientation of the input device in the physical environment.

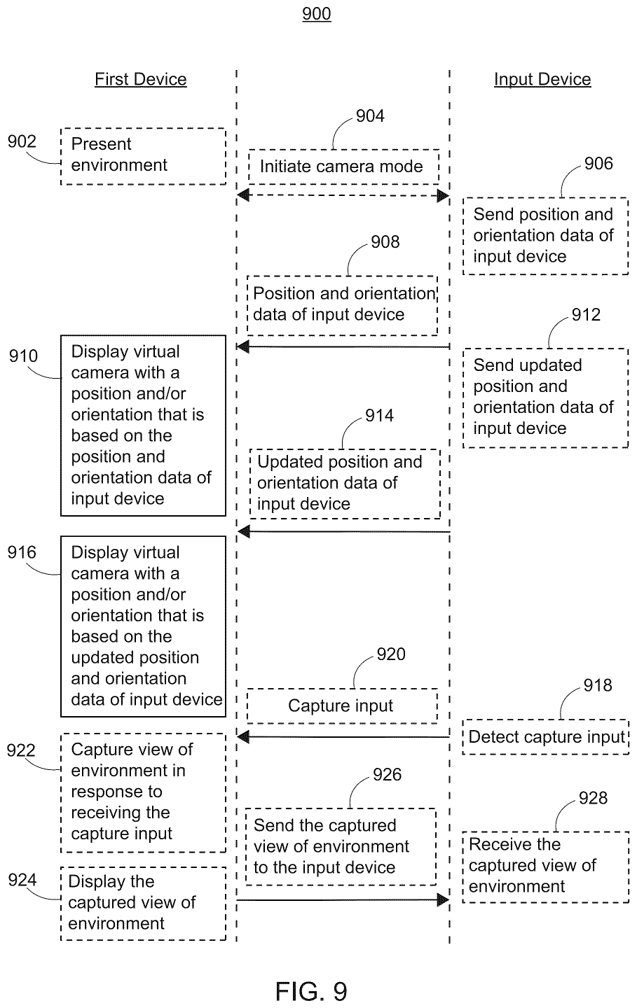

FIG. 9 is a flow diagram 900 illustrating operations and communications that first device 306 and/or the input device 308 optionally performs, in accordance with some examples.

In FIG. 9, first device optionally presents (902), via a display, an environment, such as a virtual reality environment or an augmented reality environment. While presenting the environment, the first device or the input device optionally initiates (904) a virtual camera mode. In some examples, various modes of operations are presented via the first device (and/or the input device), such as a selfie mode, a window to the physical environment mode, such as described with reference to FIG. 6, a mode in which input device is a window to the virtual environment while user of the first device is immersed in the virtual environment, such as described with reference to FIG. 7, or another mode.

In FIG. 9, input device optionally transmits (906) position and orientation data to first device. In FIG. 9, first device optionally detects or otherwise obtains (908) the position and orientation data of the input device from the input device, and displays (910) (optionally in response to detecting or obtaining the position and orientation data or optionally in response to initiating one of the virtual camera modes) a virtual camera (e.g., representation of input device 320) with a position and/or orientation that is based on the position and/or orientation data of input device. Additionally or alternatively, first device detects position and orientation data of input device via sensors of first device, without the transmission of the position and orientation data of input device from input device.

In FIG. 9, optionally after input device transmits position and orientation data to first device, input device transmits (912) updated position and orientation data to first device. In FIG. 9, first device optionally detects (914) the updated position and orientation data of the input device from the input device, and in response, displays (916) the virtual camera (e.g., representation of input device 320) with a position and/or orientation that is based on the updated position and/or orientation data of input device. For example, first device optionally updates the position of the virtual camera to be based on the updated position and/or orientation data of input device (e.g., first device optionally visually moves virtual camera from a first position and orientation in virtual environment that is based on the position and orientation data of input device from block 908 to a second position and orientation in virtual environment that is based on the updated position and orientation data of input device). While displaying the virtual camera with the position and/or orientation that is based on the updated position and/or orientation data of input device, input device optionally detects (918) a capture input for capturing one or more images from the perspective of the virtual camera, and transmits (920) the detection to first device, or optionally the first device detects the capture input. In response to detecting the capture input detection, first device captures (922) a view of the environment optionally from the perspective of the virtual camera and optionally displays (924) the captured view of the environment. The first device optionally transmits (926) the captured view of the environment to the input device, which may receive (928), store and/or display the captured view of environment.

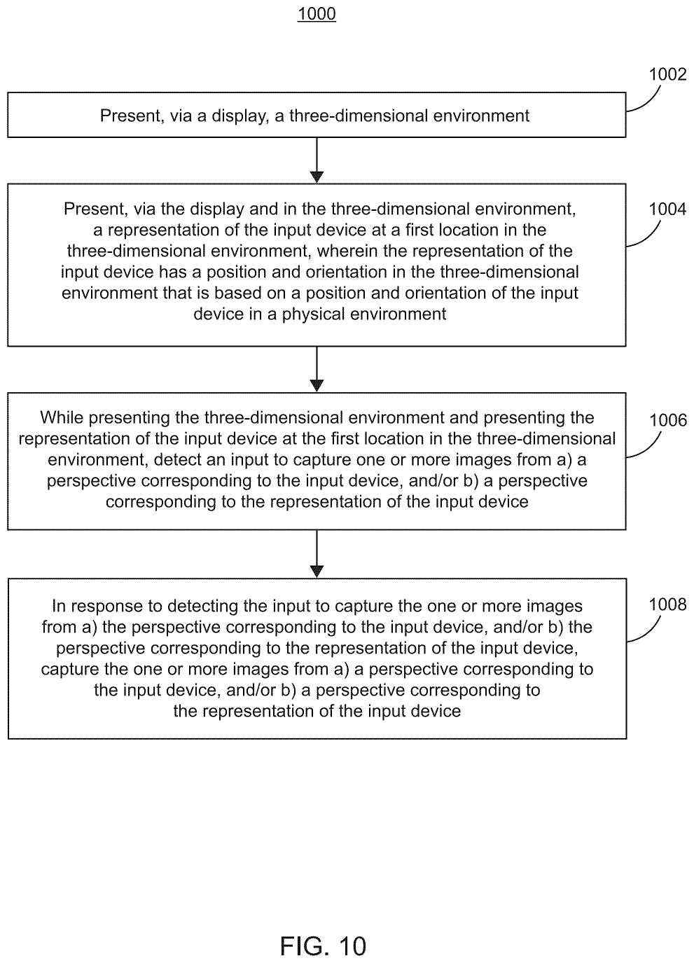

FIG. 10 illustrates a diagram of a method 1000 for capturing one or more images (e.g., of an environment and/or including real or virtual objects). In some examples, method 1000 is performed at a first device optionally in communication with a display and one or more input devices, including an input device, such as first device 306 of FIG. 2 including a display and input device 308 of FIG. 2.

In some examples, the first device presents (1002), via the display, a three-dimensional environment, such as the virtual environment 302 of FIG. 2.

In some examples, the first device presents (1004), via the display and in the three-dimensional environment, a representation of the input device at a first location in the three-dimensional environment, such as representation of the input device 320 of FIG. 2. In some examples, the representation of the input device has a position and orientation in the three-dimensional environment that is based on a position and orientation of the input device in a physical environment of the first device, such as the position and orientation of representation of input device 320 within representative coordinate system 315a (and with reference to angle 315b and vector 315c in virtual environment 302) that is based on the position and orientation of input device 308 within representative coordinate system 314a (and with reference to angle 314b and vector 314c in physical environment 300) in FIG. 2.

In some examples, while presenting the three-dimensional environment from the first viewpoint in the three-dimensional environment and presenting the representation of the input device at the first location in the three-dimensional environment, the first device detects (1006), an input to capture one or more images from a) a perspective (e.g., position, orientation, and/or view) corresponding to the input device in the physical environment, such as from a perspective of input device 308 in physical environment 300 of FIG. 2, and/or b) a perspective (e.g., position, orientation, and/or view) corresponding to the representation of the input device in the three-dimensional environment, such as from a perspective of representation of input device 320 in virtual environment 302 in FIG. 2. The input is optionally received at the first device and/or is transmitted from the input device (and to the first device).

In some examples, in response to detecting the input to capture the one or more images from a) the perspective corresponding to the input device in the physical environment, and/or b) the perspective corresponding to the representation of the input device in the three-dimensional environment, the first device captures (1008) the one or more images from a) the perspective corresponding to the input device in the physical environment, and/or b) the perspective corresponding to the representation of the input device in the three-dimensional environment. For example, in response to detecting the input to capture the one or more images from a) the perspective corresponding to the input device in the physical environment, and/or b) the perspective corresponding to the representation of the input device, first device 306 of FIG. 2 captures the one or more images from a) the perspective corresponding to the input device 308 of FIG. 2 in physical environment 300, and/or b) the perspective corresponding to representation of the input device 320 in virtual environment 302 of FIG. 2.

In some examples, the three-dimensional environment is a virtual reality environment in which a user of the first device is immersed, such as virtual environment 302 of FIG. 2. In some examples, the one or more images is one or more images of the virtual reality environment (e.g., virtual environment 302 of FIG. 2) from b) the perspective corresponding to the representation of the input device (e.g., representation of the input device 320 in virtual environment 302 of FIG. 2) in the three-dimensional environment.

In some examples, the three-dimensional environment is a virtual reality environment in which a user of the first device is immersed, such as virtual environment 302 of FIG. 2. In some examples, the one or more images is one or more images of the physical environment from a) the perspective corresponding to the input device in the physical environment, such as shown by image data 332 of FIG. 6, which is optionally captured while the user of first device 306 is immersed in virtual environment 302 of FIG. 6.

In some examples, the three-dimensional environment is an augmented reality environment. For example, first device 306 optionally presents physical environment 300 with one or more virtual objects. In some examples, the one or more images is one or more images of the augmented reality environment (e.g., of a combination of virtual environment 302 and physical environment 300 of FIG. 8) from a) the perspective corresponding to the input device in the physical environment, and b) the perspective corresponding to the representation of the input device in the three-dimensional environment, such as shown by image data 360 of FIG. 8.

In some examples, in accordance with a determination that the position and orientation of the input device in the physical environment is a first position and first orientation, the representation of the input device has a first position and first orientation in the three-dimensional environment, such as shown and described with reference to FIG. 2, and in accordance with a determination that the position and orientation of the input device in the physical environment is a second position and second orientation, different from the first position and first orientation in the physical environment, the representation of the input device has a second position and second orientation in the three-dimensional environment, different from the first position and first orientation in the three-dimensional environment, such as shown and described with reference to FIG. 3.

In some examples, the input device includes a position sensor and/or an orientation sensor, such as the sensors discussed above with reference to input device 308 of FIG. 2.

In some examples, the orientation of the representation of the input device is based on orientation data from an orientation sensor of the input device, such as the orientation of representation of input device 320 in FIG. 3 being different from the orientation of representation of input device 320 in FIG. 2 due to the change in orientation between input device 308 of FIG. 3 and input device 308 in FIG. 2

In some examples, the position and orientation of the representation of the input device in the three-dimensional environment is based on image data of the input device detected by the image sensors of the first device, such as discussed above with reference to first device 306 of FIG. 2.

In some examples, the position and orientation of the representation of the input device in the three-dimensional environment is relative to the first device's position and orientation, such as discussed above with reference to first device 306 of FIG. 2. For example, the origin of coordinate system 314a of FIG. 2 is optionally at (e.g., relative to) first device 306 and/or angle 314b and/or vector 314c are optionally relative to first device 306 of FIG. 2, such that the position and/or orientation of input device 308 is determined relative to a position and/or orientation of first device 306 of FIG. 2 and/or is optionally determined by first device 306 of FIG. 2.

In some examples, presenting the representation of the input device at the first location in the three-dimensional environment includes presenting a user interface including selectable modes of operating the representation of the input device, including a selectable selfie mode. For example, first device 306 of FIG. 2 optionally presents on representation of input device 320 a selfie mode, that when selected, initiates a process for the first device to display on the representation of input device 320 a view of virtual environment that corresponds to a virtual camera sensor on a front of representation of input device 320. In some examples, the first device (e.g., first device 306 of FIG. 2) displays in virtual environment (e.g., virtual environment 302 of FIG. 2) one or more representations of one or more body parts (e.g., arms) of the user of first device. In some examples, when operating in selfie mode, and in response to capture input, the first device (e.g., first device 306 of FIG. 2) captures an image of an avatar (e.g., a virtual spatial representation of the user that optionally includes characteristics of the user such as a representation of a head, arms, glasses, legs, and/or other body parts) of the user in the virtual environment (e.g., virtual environment 302 of FIG. 2), which first device can display on the representation of input device (e.g., representation of input device 320 of FIG. 4). In some examples, the selectable modes include an option to modify a type of representation of input device 320 (e.g., switch from a representation of digital camera to a representation of an analog camera, optionally including functionality that corresponds to digital camera and/or to an analog camera).

In some examples, the input to capture one or more images from a) a perspective corresponding to the input device, and/or b) a perspective corresponding to the representation of the input device is detected via the first device (e.g., first device 306 of FIG. 2).

In some examples, the input to capture one or more images from a) a perspective corresponding to the input device, and/or b) a perspective corresponding to the representation of the input device is detected via the input device before being detected at the first device. For example, sensors of input device 308 of FIG. 2 optionally detect the input and then optionally transmit a notification to first device 306 of FIG. 2 to indicate that the input to capture one or more images from a) a perspective corresponding to the input device, and/or b) a perspective corresponding to the representation of the input device has been detected.

In some examples, the first device captures audio associated with the one or more images from a perspective (e.g., a virtual spatial perspective) of the first device (or the user of the first device) in the three-dimensional environment. For example, while presenting virtual environment 302 of FIG. 2, first device 306 of FIG. 2 optionally presents audio associated with virtual environment 302 that corresponds to audio detected at the position and/or orientation of first device 306 in virtual environment 302, which is optionally based on a position and/or orientation of first device 306 in physical environment 300. Continuing with this example, when first device 306 detects input to capture the one or more images of virtual environment 302, first device 306 optionally initiates a process to capture audio from the perspective of a corresponding location of first device 306 in virtual environment 302, in addition to capturing the one or more images of virtual environment 302 from the perspective of representation of input device 320.

In some examples, the first device captures audio associated with the one or more images from a perspective (e.g., virtual spatial perspective) of the representation of the input device in the three-dimensional environment. For example, while presenting virtual environment 302 of FIG. 2, first device 306 of FIG. 2 optionally presents audio associated with virtual environment 302 that corresponds to spatial audio from the position and/or orientation of representation of input device 320 in virtual environment 302. Continuing with this example, when first device 306 detects input to capture the one or more images of virtual environment 302, first device optionally initiates a process to capture audio from the perspective of representation of input device 320 in virtual environment 302, in addition to capturing the one or more images of virtual environment from the perspective of representation of input device 320.

In some examples, the first device saves the captured one or more images to the first device, the input device, or to a remote server, such as first device 306 saving representation of apple 330 of FIG. 5 to input device 308 of FIG. 3.

In some examples, presenting, via the display and in the three-dimensional environment, the representation of the input device at the first location in the three-dimensional environment with the position and orientation in the three-dimensional environment (e.g., representation of input device 320 in virtual environment 302 of FIG. 2) that is based on the position and the orientation of the input device in the physical environment (e.g., input device 308 in physical environment 300 of FIG. 2) (1004) is performed in response to detecting a predefined interaction (e.g., a gaze trigger and/or an air gesture such as a pinch gesture) with the input device or the first device (e.g., with input device 308 in physical environment 300 of FIG. 2 or first device 306 of FIG. 2).

In some examples, the input device (e.g., input device 308 of FIG. 2) is a mobile phone.

In some examples, the input device (e.g., input device 308 of FIG. 2) includes one or more image capture components, such as image sensors or cameras.

In some examples, presenting, via the display and in the three-dimensional environment, the representation of the input device at the first location in the three-dimensional environment includes presenting the one or more images on the representation of the input device, such as representation of apple 330 of FIG. 5 presented on representation of input device 320 of FIG. 5.

In some examples, the one or more images (e.g., image data 360 of FIG. 8 presented on representation of input device 320 of FIG. 8) is a composition of first image data detected by image sensors of the input device, and second image data presented via the display (e.g., of first device 306 of FIG. 8) and different from image data detected by the image sensors of the input device. In some examples, a first portion of image data (e.g., the first image data) of the one or more images is processed at the input device, such as image data of physical environment 300 corresponding to or captured by an image sensor component of the input device 308 of FIG. 8, and a second portion of image data (e.g., the second image data) of the one or more images is processed at the first device such as image data of virtual environment 302 corresponding to or captured by first device 306 of FIG. 8.

In some examples, a first device including a display and/or one or more processors can perform method 1000 and/or any of the disclosed additional and/or alternative operations. In some examples, a non-transitory computer readable storage medium stores one or more programs that include instructions that when executed by a processor, cause a first device to perform method 1000 and/or any of the disclosed additional and/or alternative operations.

Various aspects of the disclosed examples, such as aspects of the examples illustrated in the drawings and details in this disclosed may be combined. In addition, although the disclosed examples have been fully described with reference to the accompanying drawings, it is to be noted that various changes and modifications will become apparent to those skilled in the art. Such changes and modifications are to be understood as being included within the scope of the disclosed examples as defined by the appended claims.

1. A method comprising:
at a first device in communication with a display and an input device:
presenting, via the display, a three-dimensional environment;
presenting, via the display and in the three-dimensional environment, a representation of the input device at a first location in the three-dimensional environment, wherein the representation of the input device has a position and an orientation in the three-dimensional environment that is based on a position and an orientation of the input device in a physical environment;
while presenting the three-dimensional environment and presenting the representation of the input device at the first location in the three-dimensional environment, detecting an input to capture one or more images from a) a perspective corresponding to the input device, and/or b) a perspective corresponding to the representation of the input device; and
in response to detecting the input, capturing the one or more images from a) the perspective corresponding to the input device, and/or b) the perspective corresponding to the representation of the input device.

2. The method of claim 1, wherein:
the three-dimensional environment is a virtual reality environment, and
the one or more images includes one or more images of the virtual reality environment from b) the perspective corresponding to the representation of the input device in the three-dimensional environment.

3. The method of claim 1, wherein:
the three-dimensional environment is a virtual reality environment, and
the one or more images includes one or more images of the physical environment from a) the perspective corresponding to the input device in the physical environment.

4. The method of claim 1, wherein:
the three-dimensional environment is an augmented reality environment, and
the one or more images includes one or more images of the augmented reality environment from a) the perspective corresponding to the input device in the physical environment, and b) the perspective corresponding to the representation of the input device in the three-dimensional environment.

5. The method of claim 1, wherein:
in accordance with a determination that the position and the orientation of the input device is a first position and a first orientation in the physical environment, the representation of the input device has a first position and a first orientation in the three-dimensional environment, and
in accordance with a determination that the position and the orientation of the input device is a second position and a second orientation in the physical environment, different from the first position and the first orientation in the physical environment, the representation of the input device has a second position and a second orientation in the three-dimensional environment, different from the first position and the first orientation in the three-dimensional environment.

6. The method of claim 1, wherein the input device includes a position sensor and/or an orientation sensor.

7. The method of claim 1, wherein the orientation of the representation of the input device is based on orientation data from an orientation sensor of the input device.

8. A first device comprising:
a display; and
one or more processors,
wherein the first device is in communication with an input device and wherein the first device is configured to perform:
presenting, via the display, a three-dimensional environment;
presenting, via the display and in the three-dimensional environment, a representation of the input device at a first location in the three-dimensional environment, wherein the representation of the input device has a position and an orientation in the three-dimensional environment that is based on a position and an orientation of the input device in a physical environment;
while presenting the three-dimensional environment and presenting the representation of the input device at the first location in the three-dimensional environment, detecting an input to capture one or more images from a) a perspective corresponding to the input device, and/or b) a perspective corresponding to the representation of the input device; and
in response to detecting the input, capturing the one or more images from a) the perspective corresponding to the input device, and/or b) the perspective corresponding to the representation of the input device.

9. The first device of claim 8, wherein the position and the orientation of the representation of the input device in the three-dimensional environment is based on image data of the input device detected by image sensors of the first device.

10. The first device of claim 8, wherein presenting the representation of the input device at the first location in the three-dimensional environment includes presenting a user interface including selectable modes of operating the representation of the input device, including a selfie mode.

11. The first device of claim 8, wherein:
the input is detected via the first device.

12. The first device of claim 8, wherein:
the input is detected via the input device before being detected at the first device.

13. The first device of claim 8, wherein the first device is configured to perform:
capturing audio associated with the three-dimensional environment from a perspective of the first device in the three-dimensional environment, the audio associated with the one or more images.

14. The first device of claim 8, wherein the first device is configured to perform:
capturing audio associated with the three-dimensional environment from a perspective of the representation of the input device in the three-dimensional environment, the audio associated with the one or more images.

15. The first device of claim 8, wherein:
presenting, via the display and in the three-dimensional environment, the representation of the input device at the first location in the three-dimensional environment with the position and orientation in the three-dimensional environment that is based on the position and the orientation of the input device in the physical environment is performed in response to detecting a predefined interaction with the input device or the first device.

16. The first device of claim 8, wherein the input device is a mobile phone.

17. A non-transitory computer readable storage medium storing one or more programs, the one or more programs comprising instructions, which when executed by a processor, cause a first device that is in communication with a display and an input device to perform:
presenting, via the display, a three-dimensional environment;
presenting, via the display and in the three-dimensional environment, a representation of the input device at a first location in the three-dimensional environment, wherein the representation of the input device has a position and an orientation in the three-dimensional environment that is based on a position and an orientation of the input device in a physical environment;
while presenting the three-dimensional environment and presenting the representation of the input device at the first location in the three-dimensional environment, detecting an input to capture one or more images from a) a perspective corresponding to the input device, and/or b) a perspective corresponding to the representation of the input device; and
in response to detecting the input, capturing the one or more images from a) the perspective corresponding to the input device, and/or b) the perspective corresponding to the representation of the input device.

18. The non-transitory computer readable storage medium of claim 17, wherein the input device includes an image capture device, and wherein capturing the one or more images of the environment from a) the perspective corresponding to the input device in the physical environment includes capturing the one or more images via the image capture device of the input device.

19. The non-transitory computer readable storage medium of claim 17, wherein:
presenting, via the display and in the three-dimensional environment, the representation of the input device at the first location in the three-dimensional environment includes presenting the one or more images on the representation of the input device.

20. The non-transitory computer readable storage medium of claim 17, wherein:
the one or more images is a composition of:
first image data detected by image sensors of the input device, and
second image data presented via the display, and different from image data detected by the image sensors of the input device,
a first portion of image data of the one or more images is processed at the input device, and
a second portion of image data of the one or more images is processed at the first device.
